(19) United States
(12) Patent Application Publication
(10) Pub. No.: US 2026/0202968 A1
(43) Pub. Date: Jul. 16, 2026

(54) DATA READING CONTROL METHOD AND MEMORY STORAGE DEVICE

(71) Applicant: Hefei Kaimeng Technology Co., Ltd., Anhui (CN)

(72) Inventors: Kuai Cao, Anhui (CN); Tsung-Lin Wu, Anhui (CN); Qiao ZHU, Anhui (CN); ShaoFeng Yang, Anhui (CN); Shuwen Sun, Anhui (CN)

(73) Assignee: Hefei Kaimeng Technology Co., Ltd., Anhui (CN)

(21) Appl. No.: 19/417,238

(22) Filed: Dec. 11, 2025

(30) Foreign Application Priority Data
Jan. 15, 2025 (CN) 202510064718.5

(51) Int. Cl. G06F 3/06

(52) U.S. Cl. CPC G06F 3/0613; G06F 3/0656; G06F 3/0659; G06F 3/0679

(57) ABSTRACT

Disclosed are a data reading control method and a memory storage device, which may enhance the quality and efficiency of constructing a sequential mapping table, thereby improving the performance of the memory storage device. The data reading control method is applicable to a rewritable non-volatile memory module. The data reading control method includes: receiving a read command and a first logical address interval corresponding thereto; determining, based on a status table, whether a first sequential mapping table corresponding to the first logical address interval exists; if the first sequential mapping table exists, performing a read operation according to the first sequential mapping table; if the first sequential mapping table does not exist, performing the read operation according to a logical-to-physical address mapping table, wherein the first sequential mapping table is different from the logical-to-physical address mapping table.

### CROSS-REFERENCE TO RELATED APPLICATION

This application claims the priority benefit of China application serial no. 202510064718.5, filed on January 15, 2025. The entirety of the above-mentioned patent application is hereby incorporated by reference herein and made a part of this specification.

### BACKGROUND

### Technical Field

The present disclosure pertains to storage technology, and more particularly, relates to a data reading control method and a memory storage device.

### Description of Related Art

In recent years, the rapid growth of smartphones, tablet computers, and personal computers has significantly increased consumer demand for storage media. Rewritable non-volatile memory modules (e.g., flash memory) are particularly well-suited for integration into the aforementioned portable multimedia devices due to their characteristics of data non-volatility, energy efficiency, compact size, and lack of mechanical structures.

Generally, in memory storage devices, one or more mapping tables are established and maintained to record a mapping relationship between physical addresses and logical addresses. When a host system intends to read data from or write data to a rewritable non-volatile memory module, a memory management circuit (e.g., memory controller) may, for instance, look up the mapping table to obtain a physical address corresponding to a logical address, thereby executing a data access operation on the rewritable non-volatile memory module. However, in memory storage devices, the lookup or search of the mapping table is typically a time-consuming and energy-intensive operation.

The optimization of operations for searching a mapping table is an urgent technical issue that requires resolution.

### SUMMARY

An exemplary embodiment of the present disclosure provides a data reading control method and a memory storage device, which may enhance the performance of a memory storage device.

An exemplary embodiment of the present disclosure provides a data reading control method for a rewritable non-volatile memory module. The data reading control method includes: receiving a read command and a first logical address interval corresponding thereto; determining, according to a status table, whether a first sequential mapping table corresponding to the first logical address interval exists; if the first sequential mapping table exists, performing a read operation based on the first sequential mapping table; if the first sequential mapping table does not exist, performing the read operation based on a logical-to-physical address mapping table, wherein the first sequential mapping table is different from the logical-to-physical address mapping table.

In an exemplary embodiment of the present disclosure, the data reading control method further includes: constructing the status table; and constructing multiple sequential mapping tables, wherein the status table includes multiple status identifiers, and the multiple status identifiers respectively correspond to multiple logical address intervals. Each of the status identifiers is provided to characterize whether there is a sequential mapping table corresponding to a logical address interval corresponding to the status identifier. The multiple sequential mapping tables include the first sequential mapping table, and the multiple logical address intervals include the first logical address interval.

In an exemplary embodiment of the present disclosure, the data reading control method further includes: upon detecting that a trigger condition is met while executing multiple read operations, traversing the status table to query multiple consecutive segments; determining whether the multiple consecutive segments satisfy a preset condition; if so, arranging the multiple consecutive segments in a descending order, and copying a second sequential mapping table corresponding to a top first quantity of consecutive segments among the multiple consecutive segments to a sequential mapping buffer memory, wherein the multiple sequential mapping tables include the second sequential mapping table.

In an exemplary embodiment of the present disclosure, the step of determining whether the multiple consecutive segments satisfy the preset condition includes: determining whether the quantity of the multiple consecutive segments falls within a preset interval; if the quantity of the multiple consecutive segments falls within the preset interval, then determining whether a total quantity of status identifiers within the multiple consecutive segments is greater than a third quantity; if so, then determining that the multiple consecutive segments satisfy the preset condition.

In an exemplary embodiment of the present disclosure, the step of determining whether the multiple consecutive segments satisfy the preset condition further includes: if the quantity does not fall within the preset interval, determining whether the quantity is greater than a preset quantity; if the quantity is greater than the preset quantity, then determining whether a total quantity of status identifiers within a second quantity of consecutive segments, having more status identifiers among the multiple consecutive segments, is greater than the third quantity; if so, determining that the multiple consecutive segments satisfy the preset condition.

In an exemplary embodiment of the present disclosure, the trigger condition is that the quantity of the multiple read operations is greater than a preset value, or an amount of read data corresponding to the multiple read operations is greater than a preset amount of data.

In an exemplary embodiment of the present disclosure, among the multiple status identifiers, the status identifiers that are associated with a first logical value are provided to characterize the presence of the sequential mapping table that corresponds to the logical address interval corresponding to the status identifiers. Among the multiple status identifiers, the status identifiers that are associated with a second logical value are provided to characterize the absence of the sequential mapping table corresponding to the logical address interval corresponding to the status identifiers.

In an exemplary embodiment of the present disclosure, each of the consecutive segments includes consecutive status identifiers, and the consecutive status identifiers are at least two adjacent status identifiers within the multiple status identifiers, wherein the at least two adjacent status identifiers both have the first logical value.

In an exemplary embodiment of the present disclosure, the step of traversing the status table to query the multiple consecutive segments includes: if the status identifier associated with the second logical value is queried, a subsequent fourth quantity of status identifiers are not queried.

In an exemplary embodiment of the present disclosure, the fourth quantity is associated with logical address intervals corresponding to consecutive write operations.

In an exemplary embodiment of the present disclosure, the step of arranging the multiple consecutive segments in the descending order includes arranging the multiple consecutive segments in the descending order based on a quantity of status identifiers included therein.

An exemplary embodiment of the present disclosure further provides a memory storage device, which includes a connection interface unit, a rewritable non-volatile memory module, and a memory control circuit unit. The memory control circuit unit is coupled to the connection interface unit and the rewritable non-volatile memory module. The memory control circuit unit includes a sequential mapping buffer memory. The connection interface unit is configured to couple to a host system. The memory control circuit unit is configured to receive a read command and a first logical address interval corresponding thereto. The memory control circuit unit is further configured to determine, based on a status table, whether a first sequential mapping table corresponding to the first logical address interval exists. If the first sequential mapping table exists, the memory control circuit unit is further configured to perform a read operation according to the first sequential mapping table. If the first sequential mapping table does not exist, the memory control circuit unit is further configured to perform the read operation based on a logical-to-physical address mapping table, wherein the first sequential mapping table is different from the logical-to-physical address mapping table.

In an exemplary embodiment of the present disclosure, the memory control circuit unit is also configured to construct the status table and multiple sequential mapping tables, wherein the status table includes multiple status identifiers, the multiple status identifiers respectively correspond to multiple logical address intervals. Each of the status identifiers is provided to characterize whether there is a sequential mapping table corresponding to a logical address interval corresponding to the status identifier. The multiple sequential mapping tables include the first sequential mapping table, and the multiple logical address intervals include the first logical address interval.

In an exemplary embodiment of the present disclosure, the memory control circuit unit is further configured to detect when a trigger condition is met during the execution of multiple read operations. The memory control circuit unit is further configured to traverse the status table to query multiple consecutive segments. Additionally, the memory control circuit unit is configured to determine whether the multiple consecutive segments satisfy a preset condition. If so, the memory control circuit unit is further configured to arrange the multiple consecutive segments in a descending order and to copy a second sequential mapping table corresponding to a top first quantity of consecutive segments among the multiple consecutive segments to a sequential mapping buffer memory, wherein the multiple sequential mapping table includes the second sequential mapping table.

In an exemplary embodiment of the present disclosure, the memory control circuit unit is further configured to determine whether the quantity of the multiple consecutive segments falls within a preset interval. If the quantity of the multiple consecutive segments falls within the preset interval, the memory control circuit unit is further configured to determine whether a total quantity of status identifiers within the multiple consecutive segments is greater than a third quantity. If so, the memory control circuit unit is further configured to determine that the multiple consecutive segments satisfy the preset condition.

In an exemplary embodiment of the present disclosure, if the quantity does not fall within the preset interval, the memory control circuit unit is further configured to determine whether the quantity is greater than a preset quantity; if the quantity is greater than the preset quantity, then the memory control circuit unit is further configured to determine whether a total quantity of status identifiers within a second quantity of consecutive segments, having more status identifiers among the multiple consecutive segments, is greater than the third quantity. If so, the memory control circuit unit is further configured to determine that the multiple consecutive segments satisfy the preset condition.

In an exemplary embodiment of the present disclosure, if the status identifier associated with a second logical value is queried, the memory control circuit unit is further configured not to query a subsequent fourth quantity of status identifiers.

In an exemplary embodiment of the present disclosure, the memory control circuit unit is further configured to arrange the multiple consecutive segments in the descending order based on a quantity of status identifiers included therein.

Based on the foregoing, the present disclosure provides a data reading control method and a memory storage device, which optimize a management mechanism for the sequential mapping table based on the consecutiveness of the status table (i.e., multiple consecutive segments in the status table). The read operation is executed according to the sequential mapping table, thereby reducing the time required to load the mapping table and enhancing the performance of the memory storage device.

In order to make the aforementioned features and advantages of the present disclosure more comprehensible, the following embodiments are provided, accompanied by detailed descriptions and illustrations with reference to the accompanying drawings.

### BRIEF DESCRIPTION OF THE DRAWINGS

FIG. 1 is a schematic diagram illustrating a host system, a memory storage device, and an input/output (I/O) device according to an exemplary embodiment of the present disclosure.

FIG. 2 is a schematic diagram illustrating the host system, the memory storage device, and the I/O device according to an exemplary embodiment of the present disclosure.

FIG. 3 is a schematic diagram illustrating the host system and memory storage device according to an exemplary embodiment of the present disclosure.

FIG. 4 is a schematic diagram illustrating a memory storage device according to an exemplary embodiment of the present disclosure.

FIG. 5 is a schematic diagram illustrating a memory control circuit unit according to an exemplary embodiment of the present disclosure.

FIG. 6 is a schematic diagram illustrating management of a rewritable non-volatile memory module according to an exemplary embodiment of the present disclosure.

FIG. 7 is a schematic diagram illustrating a status table and a sequential mapping table according to an exemplary embodiment of the present disclosure.

FIG. 8 illustrates a flowchart depicting a data reading control method according to an exemplary embodiment of the present disclosure.

FIG. 9 illustrates a flowchart depicting a data reading control method according to an exemplary embodiment of the present disclosure.

### DESCRIPTION OF THE EMBODIMENTS

The detailed exemplary embodiments of the present disclosure will now be referenced, with instances of exemplary embodiments illustrated in the accompanying drawings. Where possible, identical reference symbols are used in the drawings and description to denote identical or similar parts.

Generally, a memory storage device (also referred to as a memory storage system) includes a rewritable non-volatile memory module and a controller (also known as a control circuit). The memory storage device may be used in conjunction with a host system to enable the host system to write data to the memory storage device or read data from the memory storage device.

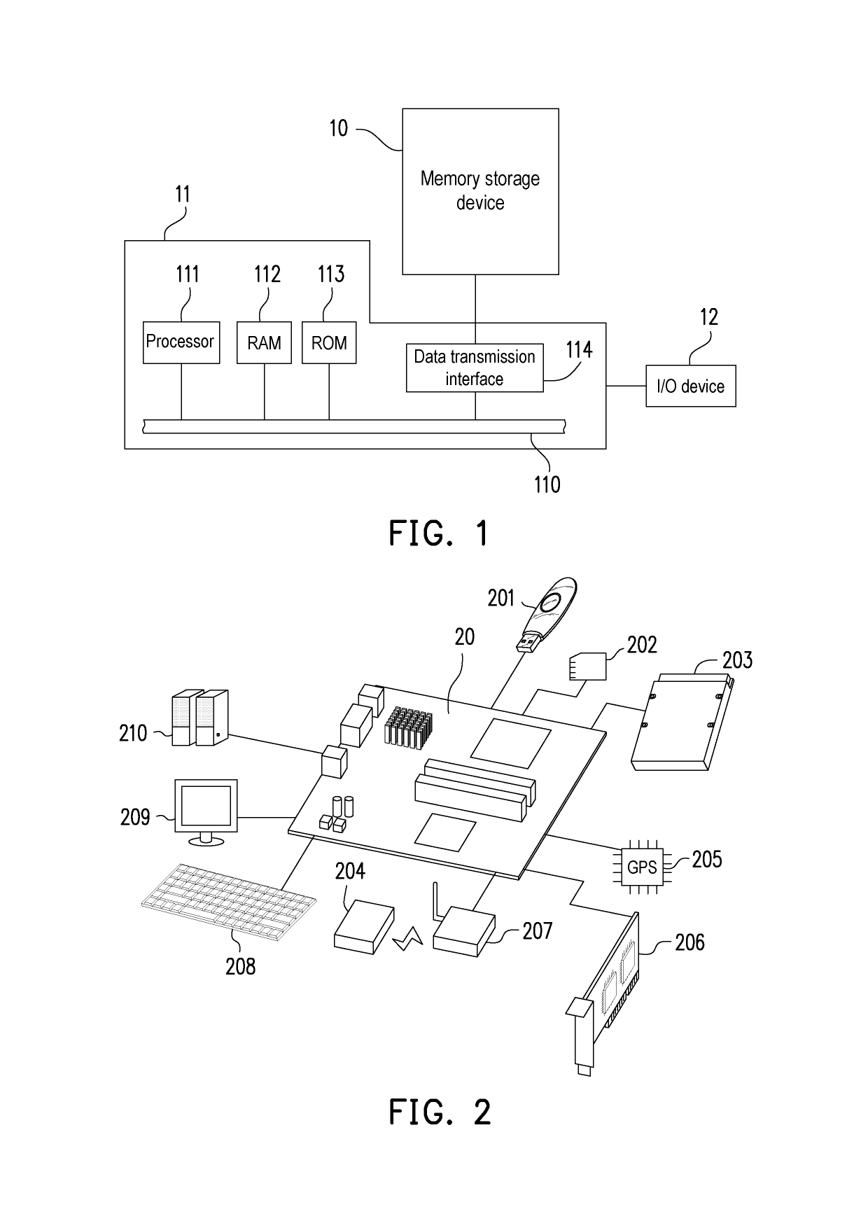

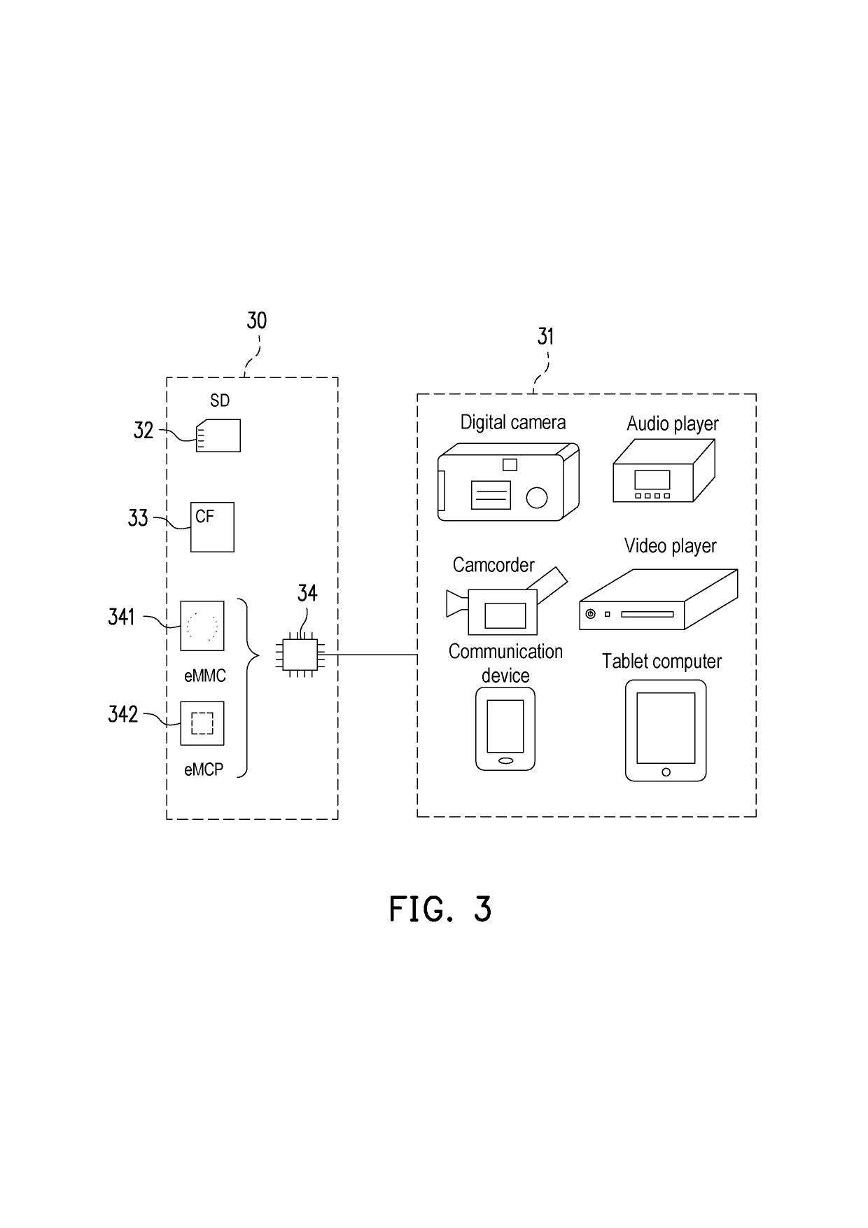

FIG. 1 is a schematic diagram illustrating a host system, a memory storage device, and an input/output (I/O) device according to an exemplary embodiment of the present disclosure. FIG. 2 is a schematic diagram illustrating the host system, the memory storage device, and the I/O device according to an exemplary embodiment of the present disclosure.

Please refer to FIG. 1 and FIG. 2. The host system 11 may include a processor 111, a random access memory (RAM) 112, a read-only memory (ROM) 113, and a data transmission interface 114. The processor 111, the random access memory 112, the read-only memory 113, and the data transmission interface 114 may be coupled to a system bus 110.

In an exemplary embodiment, a host system 11 may be coupled to a memory storage device 10 through the data transmission interface 114. For instance, the host system 11 may store data to the memory storage device 10 or read data from the memory storage device 10 through the data transmission interface 114. Additionally, the host system 11 may be coupled to an I/O device 12 through the system bus 110. For example, the host system 11 may transmit output signals to the I/O device 12 or receive input signals from the I/O device 12 through the system bus 110.

In an exemplary embodiment, the processor 111, the random access memory 112, the read-only memory 113, and the data transmission interface 114 may be configured on a motherboard 20 of the host system 11. The quantity of the data transmission interfaces 114 may be one or more. Through the data transmission interface 114, the motherboard 20 may be coupled to the memory storage device 10 in a wired or wireless manner.

In an exemplary embodiment, the memory storage device 10 may be, for example, a USB flash drive 201, a memory card 202, a Solid State Drive (SSD) 203, or a wireless memory storage device 204. The wireless memory storage device 204 may include, for example, a Near Field Communication (NFC) memory storage device, a WiFi memory storage device, a Bluetooth memory storage device, or a low-energy Bluetooth memory storage device (e.g., iBeacon) based on various wireless communication technologies. Additionally, the motherboard 20 may also be coupled to various I/O devices such as a Global Positioning System (GPS) module 205, a network interface card 206, a wireless transmission device 207, a keyboard 208, a screen 209, a speaker 210, and others through the system bus 110. For instance, in an exemplary embodiment, the motherboard 20 may access the wireless memory storage device 204 through the wireless transmission device 207.

In an exemplary embodiment, the host system 11 is a computer system. In another exemplary embodiment, the host system 11 may be any system that can substantially cooperate with a memory storage device to store data. In yet another exemplary embodiment, the host system 11 is a vehicle-mounted system. In an exemplary embodiment, the memory storage device 10 and the host system 11 may respectively include a memory storage device 30 and a host system 31 as depicted in FIG. 3.

FIG. 3 is a schematic diagram illustrating the host system and memory storage device according to an exemplary embodiment of the present disclosure.

Please refer to FIG. 3. The memory storage device 30 may be used in conjunction with the host system 31 for data storage. For example, the host system 31 may be a digital camera, a camcorder, a communication device, an audio player, a video player, or a tablet computer. For example, the memory storage device 30 may include various types of non-volatile memory storage devices used by the host system 31, such as a Secure Digital (SD) card 32, a Compact Flash (CF) card 33, or an embedded storage device 34. The embedded storage device 34 includes various types of embedded storage devices that directly couple memory modules to substrates of the host system, including an embedded MultiMediaCard (eMMC) 341 and/or an embedded Multi-Chip Package (eMCP) storage device 342.

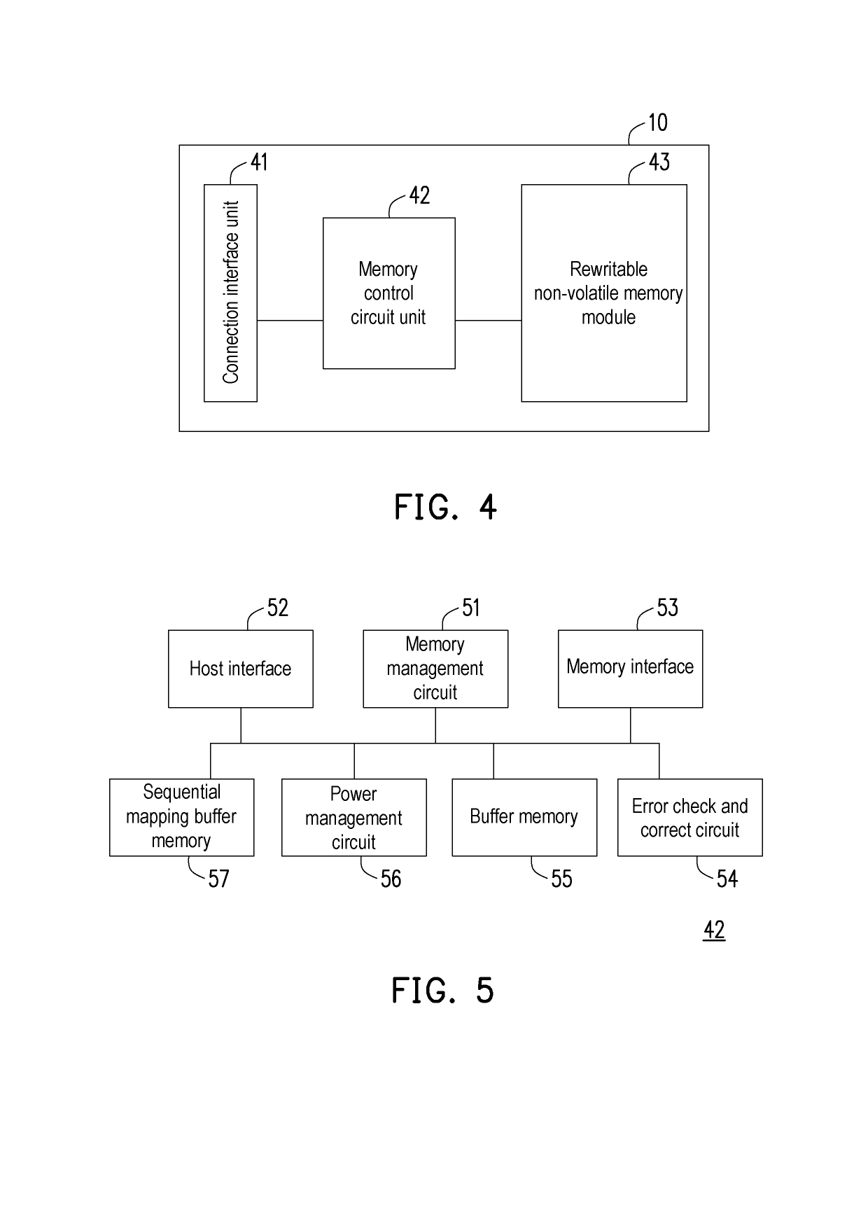

FIG. 4 is a schematic diagram illustrating a memory storage device according to an exemplary embodiment of the present disclosure.

Please refer to FIG. 4, where the memory storage device 10 includes a connection interface unit 41, a memory control circuit unit 42, and a rewritable non-volatile memory module 43.

The connection interface unit 41 is provided to couple the memory storage device 10 to the host system 11. The memory storage device 10 may communicate with the host system 11 through the connection interface unit 41. In an exemplary embodiment, the connection interface unit 41 is compatible with the Peripheral Component Interconnect Express (PCI Express) standard. In another exemplary embodiment, the connection interface unit 41 may also conform to standards such as the Serial Advanced Technology Attachment (SATA), Parallel Advanced Technology Attachment (PATA), Institute of Electrical and Electronics Engineers (IEEE) 1394, Universal Serial Bus (USB), SD interface standard, Ultra High Speed-I (UHS-I) interface standard, Ultra High Speed-II (UHS-II) interface standard, Memory Stick (MS) interface standard, MCP interface standard, MMC interface standard, eMMC interface standard, Universal Flash Storage (UFS) interface standard, eMCP interface standard, CF interface standard, Integrated Device Electronics (IDE) standard, or other suitable standards. The connection interface unit 41 may be packaged in the same chip as the memory control circuit unit 42, or the connection interface unit 41 may be arranged outside a chip that includes the memory control circuit unit 42.

The memory control circuit unit 42 is coupled to the connection interface unit 41 and the rewritable non-volatile memory module 43. The memory control circuit unit 42 is designed to execute multiple logical gates or control commands implemented in the form of hardware or firmware, and performs operations such as writing, reading, and erasing data in the rewritable non-volatile memory module 43 based on the commands from the host system 11.

The rewritable non-volatile memory module 43 is provided for storing data written by the host system 11. The rewritable non-volatile memory module 43 may include a Single Level Cell (SLC) NAND flash memory module (i.e., a flash memory module capable of storing 1 bit per memory cell), a Multi Level Cell (MLC) NAND flash memory module (i.e., a flash memory module capable of storing 2 bits per memory cell), a Triple Level Cell (TLC) NAND flash memory module (i.e., a flash memory module capable of storing 3 bits per memory cell), a Quad Level Cell (QLC) NAND flash memory module (i.e., a flash memory module capable of storing 4 bits per memory cell), other flash memory modules, or other memory modules with similar characteristics.

Each memory cell in the rewritable non-volatile memory module 43 stores one or more bits through the alteration of voltage, hereinafter also referred to as a threshold voltage. Specifically, there is a charge trapping layer between a control gate of each memory cell and a channel. By applying a write voltage to the control gate, the amount of electrons in the charge trapping layer may be altered, thereby changing the threshold voltage of the memory cell. This operation of changing the threshold voltage of a memory cell is also referred to as "writing data to the memory cell" or "programming the memory cell." With the change in threshold voltage, each memory cell in the rewritable non-volatile memory module 43 possesses multiple storage states. By applying a read voltage, it may be determined which storage state a memory cell belongs to, thereby retrieving the one or more bits stored in the memory cell.

In an exemplary embodiment, the memory cells of the rewritable non-volatile memory module 43 may be configured as multiple physical programmable units, and the physical programmable units may constitute multiple physical units. Specifically, the memory cells on the same word line may form one or more physical programmable units. If each memory cell is capable of storing two or more bits, the physical programmable units on the same word line may be at least classified into lower physical programmable units and upper physical programmable units. For instance, the Least Significant Bit (LSB) of a memory cell belongs to the lower physical programmable unit, and the Most Significant Bit (MSB) of a memory cell belongs to the upper physical programmable unit. Generally, in the MLC NAND flash memory, the write speed of the lower physical programmable unit is greater than that of the upper physical programmable unit, and/or the reliability of the lower physical programmable unit is higher than that of the upper physical programmable unit.

In an exemplary embodiment, a physical programmable unit is the minimum unit of programming. That is, the physical programmable unit is the minimum unit for writing data. For example, the physical programmable unit may be a physical page or a physical sector. If the physical programmable unit is a physical page, such physical programmable units may include a data bit area and a redundancy bit area. The data bit area contains multiple physical sectors for storing user data, while the redundancy bit area is configured to store system data (e.g., error correction codes and other management data). In this exemplary embodiment, the data bit area contains 32 physical sectors, with each physical sector being 512 bytes in size. However, in other exemplary embodiments, the data bit area may contain 8, 16, or any other number of physical sectors, and the size of each physical sector may vary to be larger or smaller. On the other hand, the physical unit is the minimum unit of erasure. That is, each physical unit contains the minimum number of memory cells erased together. For example, the physical unit may be a physical block.

FIG. 5 is a schematic diagram illustrating a memory control circuit unit according to an exemplary embodiment of the present disclosure.

Please refer to FIG. 5. The memory control circuit unit 42 includes a memory management circuit 51, a host interface 52, and a memory interface 53.

The memory management circuit 51 is configured to control the overall operation of the memory control circuit unit 42. Specifically, the memory management circuit 51 possesses multiple control commands, and during the operation of the memory storage device 10, these control commands are executed to perform operations such as data writing, reading, and erasure. The following description of the operation of the memory management circuit 51 is equivalent to the description of the operation of the memory control circuit unit 42.

In an exemplary embodiment, the control commands of the memory management circuit 51 are implemented in the form of firmware. For instance, the memory management circuit 51 includes a microprocessor unit (not shown) and a read-only memory (not shown), and these control commands are encoded into the read-only memory. When the memory storage device 10 is in operation, these control commands are executed by the microprocessor unit to perform operations such as data writing, reading, and erasure.

In an exemplary embodiment, the control commands of the memory management circuit 51 may also be stored in the form of codes within a specific area of the rewritable non-volatile memory module 43 (for example, a system area of the memory module dedicated to storing system data). Furthermore, the memory management circuit 51 includes a microprocessor unit (not shown), a read-only memory (not shown), and a random-access memory (not shown). Specifically, the read-only memory contains a boot code, and when the memory control circuit unit 42 is enabled, the microprocessor unit first executes the boot code to load the control commands stored in the rewritable non-volatile memory module 43 into the random-access memory of the memory management circuit 51. Subsequently, the microprocessor unit executes these control commands to perform operations such as writing, reading, and erasing data.

In an exemplary embodiment, the control commands of the memory management circuit 51 may also be implemented in the form of hardware. For instance, the memory management circuit 51 includes a microcontroller, a memory cell management circuit, a memory write circuit, a memory read circuit, a memory erase circuit, and a data processing circuit. The memory cell management circuit, the memory write circuit, the memory read circuit, the memory erase circuit, and the data processing circuit are coupled to the microcontroller. The memory cell management circuit is configured to manage memory cells or groups of the memory cells within the rewritable non-volatile memory module 43. The memory write circuit issues write command sequences to the rewritable non-volatile memory module 43 to write data into the rewritable non-volatile memory module 43. The memory read circuit issues read command sequences to the rewritable non-volatile memory module 43 to read data from the rewritable non-volatile memory module 43. The memory erase circuit issues erase command sequences to the rewritable non-volatile memory module 43 to erase data from the rewritable non-volatile memory module 43. The data processing circuit processes data intended to be written to the rewritable non-volatile memory module 43 or read from the rewritable non-volatile memory module 43. The write command sequences, the read command sequences, and the erase command sequences may each include one or more codes or command codes and are used to instruct the rewritable non-volatile memory module 43 to perform the corresponding write, read, and erase operations. In an exemplary embodiment, the memory management circuit 51 may further issue other types of command sequences to the rewritable non-volatile memory module 43 to instruct the rewritable non-volatile memory module 43 to perform corresponding operations.

The host interface 52 is coupled to the memory management circuit 51. The memory management circuit 51 may communicate with the host system 11 through the host interface 52. The host interface 52 may be configured to receive and identify commands and data transmitted by the host system 11. For instance, commands and data transmitted by the host system 11 may be transmitted to the memory management circuit 51 through the host interface 52. Furthermore, the memory management circuit 51 may transmit data to the host system 11 through the host interface 52. In this exemplary embodiment, the host interface 52 is compatible with the PCI Express standard. However, it should be understood that the present disclosure is not limited thereto, as the host interface 52 may also be compatible with the SATA standard, PATA standard, IEEE 1394 standard, USB standard, SD standard, UHS-I standard, UHS-II standard, MS standard, MMC standard, eMMC standard, UFS standard, CF standard, IDE standard, or any other suitable data transmission standard.

The memory interface 53 is coupled to the memory management circuit 51 and is configured to access the rewritable non-volatile memory module 43. For instance, the memory management circuit 51 may access the rewritable non-volatile memory module 43 through the memory interface 53. In other words, data intended to be written to the rewritable non-volatile memory module 43 is converted through the memory interface 53 into a format that the rewritable non-volatile memory module 43 can accept. Specifically, if the memory management circuit 51 is to access the rewritable non-volatile memory module 43, the memory interface 53 will transmit the corresponding command sequences. For example, the command sequences may include write command sequences indicating data to be written, read command sequences indicating data to be read, erase command sequences indicating data to be erased, as well as corresponding command sequences provided to indicate various memory operations (such as changing read voltage levels or performing garbage collection operations, etc.). The command sequences are, for example, generated by the memory management circuit 51 and transmitted to the rewritable non-volatile memory module 43 through the memory interface 53. The command sequences may include one or more signals or data on a bus. The signals or data may include command codes or codes. For instance, in a read command sequence, information such as the read identification code and memory address will be included.

In an exemplary embodiment, the memory control circuit unit 42 further includes an error check and correct circuit 54, a buffer memory 55, a power management circuit 56, and a sequential mapping buffer memory 57.

The error check and correct circuit 54 is coupled to the memory management circuit 51 and is configured to perform error check and correct operations to ensure accuracy of data. Specifically, when the memory management circuit 51 receives a write command from the host system 11, the error check and correct circuit 54 generates a corresponding error correcting code (ECC) and/or an error detecting code (EDC) for the data associated with the write command. The memory management circuit 51 then writes the data associated with the write command along with the corresponding error correcting code and/or the error detecting code into the rewritable non-volatile memory module 43. Subsequently, when the memory management circuit 51 reads data from the rewritable non-volatile memory module 43, the memory management circuit 51 simultaneously reads the error correcting code and/or the error detecting code associated with the data. The error check and correct circuit 54 then performs the error check and correct operations on the read data based on the error correcting code and/or the error detecting code.

The buffer memory 55 is coupled to the memory management circuit 51 and is configured for storing data temporarily. The power management circuit 56 is coupled to the memory management circuit 51 and is configured for controlling the power supply of the memory storage device 10. The sequential mapping buffer memory 57 is coupled to the memory management circuit 51 and is configured for storing the sequential mapping table.

In an exemplary embodiment, the rewritable non-volatile memory module 43 illustrated in FIG. 4 may include a flash memory module. In an exemplary embodiment, the memory control circuit unit 42 illustrated in FIG. 4 may include a flash memory controller. In an exemplary embodiment, the memory management circuit 51 illustrated in FIG. 5 may include a flash memory management circuit.

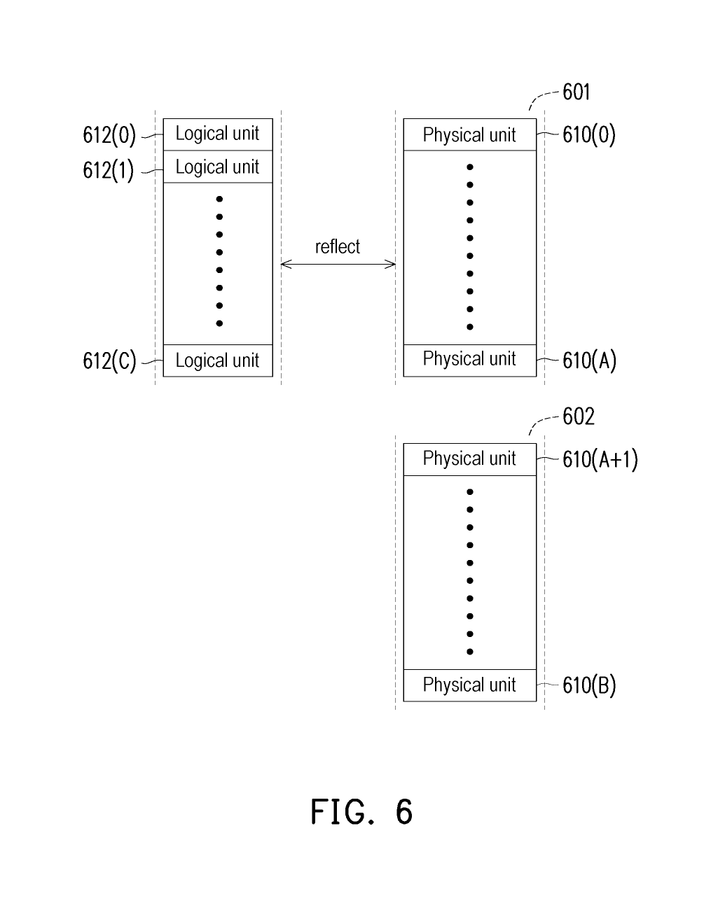

FIG. 6 is a schematic diagram illustrating management of a rewritable non-volatile memory module according to an exemplary embodiment of the present disclosure.

Please refer to FIG. 6. The memory management circuit 51 may logically group physical units 610(0) to 610(B) within the rewritable non-volatile memory module 43 into a storage area 601 and a spare area 602. A physical unit refers to a virtual block (VB). A virtual block may include multiple physical programmable units. For instance, a virtual block may contain one or more physical units.

The physical units 610(0) to 610(A) within storage area 601 are provided to store user data (for example, user data from the host system 11 depicted in FIG. 1). For instance, the physical units 610(0) to 610(A) in the storage area 601 may contain both valid and invalid data. The physical units 610(A+1) to 610(B) in the spare area 602 do not store any data (for example, valid data). For example, if a particular physical unit does not store valid data, such physical unit may be associated with (or added to) the spare area 602. Additionally, the physical units in the spare area 602 (or those physical units not storing valid data) may be erased. When new data is to be written, one or more physical units may be retrieved from the spare area 602 to store this new data. In an exemplary embodiment, the spare area 602 is also referred to as a free pool.

The memory management circuit 51 may be configured with logical units 612(0) through 612(C) to map physical units 610(0) through 610(A) within the storage area 601. In an exemplary embodiment, each logical unit corresponds to a logical address. For instance, a logical address may include one or more logical block addresses (LBA) or other logical management units.

It should be noted that a logical unit may be mapped to one or more physical units. If a particular physical unit is currently mapped to a logical unit, it indicates that the data stored in this physical unit contains valid data. Conversely, if a particular physical unit is not currently mapped to any logical unit, it indicates that the data stored in this physical unit does not contain any valid data.

The memory management circuit 51 may record management data, which describe a mapping relationship between logical units and physical units (also referred to as logical-to-physical mapping information), in at least one logical-to-physical mapping table. When the host system 11 intends to read data from the memory storage device 10 or write data to the memory storage device 10, the memory management circuit 51 may perform data access operations on the memory storage device 10 based on the information in the logical-to-physical mapping table.

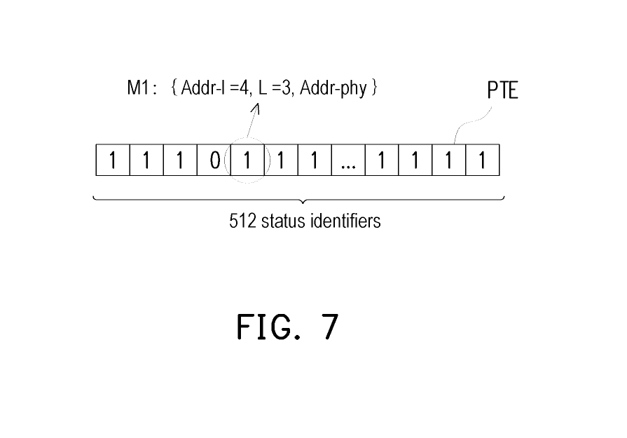

FIG. 7 is a schematic diagram illustrating a status table and a sequential mapping table according to an exemplary embodiment of the present disclosure.

Please refer to FIG. 7, the memory management circuit 51 is capable of recording management information that describes a mapping relationship between a logical address interval and a physical address interval in a sequential mapping table, and constructing a status table PTE to manage the sequential mapping table. In an exemplary embodiment, the status table PTE may include, for instance, multiple (e.g., 512) status identifiers, with each status identifier corresponding to a logical address interval. For example, each status identifier corresponds to a logical address interval of 4 kB in size. The logical address interval includes addresses of multiple logical units. Similarly, the physical address interval includes addresses of multiple physical units.

In an exemplary embodiment, each status identifier is provided to characterize whether there is a sequential mapping table corresponding to the logical address interval corresponding to the status identifier. Specifically, the multiple status identifiers may be respectively associated with a first logical value (e.g., logical value 1) or a second logical value (e.g., logical value 0). For instance, a status identifier associated with the logical value 1 is provided to characterize that a logical address interval corresponding to the status identifier has been mapped to one or more physical address intervals. In other words, the status identifier associated with the logical value 1 is provided to characterize the presence of the sequential mapping table corresponding to the logical address interval corresponding to the status identifier. For example, a status identifier associated with the logical value 0 is provided to characterize that a logical address interval corresponding to the status identifier has not been mapped to a physical address interval. In other words, the status identifier associated with the logical value 0 is provided to characterize the absence of the sequential mapping table corresponding to the logical address interval corresponding to the status identifier.

In an exemplary embodiment, the memory management circuit 51 may perform a read operation on the memory storage device 10 according to the sequential mapping table or the aforementioned logical-to-physical mapping table. Specifically, when the host system 11 is to read data from the memory storage device 10, the memory management circuit 51 may receive a read command and a logical address interval (also known as the first logical address interval) corresponding thereto. The memory management circuit 51 may determine, based on the status table PTE, whether there is a sequential mapping table (also referred to as the first sequential mapping table) corresponding to the first logical address interval.

In an exemplary embodiment, it is assumed that the first logical address interval corresponds to a fifth status identifier in the status table PTE. As illustrated in FIG. 7, the fifth status identifier pertains to the first logical value (i.e., logical value 1), indicating the presence of a first sequential mapping table M1 corresponding to the first logical address interval. Consequently, the memory management circuit 51 may execute a read operation based on the first sequential mapping table M1.

Specifically, the sequential mapping table M1 includes, but is not limited to, a starting logical address Addr-l, a length L, and a starting physical address Addr-phy. The starting logical address Addr-l is a starting address of the logical address interval included in the sequential mapping table M1. The length L refers to a length of the logical address interval included in the sequential mapping table M1. The starting physical address Addr-phy corresponds to a starting address of the physical address interval corresponding to the logical address interval. As illustrated in FIG. 7, the starting logical address Addr-l is 4 and the length L is 3. Since the first logical address interval corresponds to the fifth status identifier in the status table PTE (meaning that the first logical address interval is the fifth logical address interval characterized by the status table PTE), and the starting logical address Addr-l is 4 (meaning that the starting address of the logical address interval included in the sequential mapping table M1 is the starting address of the fourth logical address interval), the memory management circuit 51 may calculate a difference (also referred to as an offset) between the starting address (i.e., the starting address of the fourth logical address interval) and the starting address of the currently requested logical address interval (i.e., the fifth logical address interval), which is 1 (i.e., the length of one logical address interval). Subsequently, the memory management circuit 51 may obtain the physical address of the physical address interval to which the first logical address interval is mapped, based on the starting physical address Addr-phy, the length L, and the offset, thereby completing the read operation.

In a specific exemplary embodiment, it is assumed that the first logical address interval corresponds to a fourth status identifier in the status table PTE. As illustrated in FIG. 7, the fourth status identifier is associated with the second logical value (i.e., logical value 0), which characterizes the absence of the first sequential mapping table corresponding to the first logical address interval. Consequently, the memory management circuit 51 needs to perform a read operation according to the aforementioned logical-to-physical mapping table.

It is necessary to note that the logical-to-physical mapping table is utilized to record a mapping relationship between each logical unit and the physical unit. In contrast, the sequential mapping table only contains the following information: the starting physical address Addr-phy, the length L, and the starting physical address Addr-phy. The limited information is sufficient to characterize the mapping relationship between the logical address interval and the physical address interval. Consequently, the logical-to-physical mapping table requires more storage space compared to the sequential mapping table. Furthermore, the loading time for the logical-to-physical mapping table is also longer than that of the sequential mapping table.

It is noteworthy that if the write data from the host system 11 is non-consecutive, a logical unit corresponding to the write data may be mapped to multiple physical units. In such circumstances, when the host system 11 intends to read data belonging to this logical unit, the memory management circuit 51 must load different logical-to-physical mapping tables multiple times to execute the read operation. Such approach may result in a slower read speed, dramatically affecting the performance of the memory storage device 10.

Accordingly, the memory management circuit 51 of the present disclosure may determine whether to use the logical-to-physical mapping table or the sequential mapping table to execute read operations by referencing the status table PTE. Such capability may accelerate the execution efficiency of read operations, thereby enhancing the performance of the memory storage device 10.

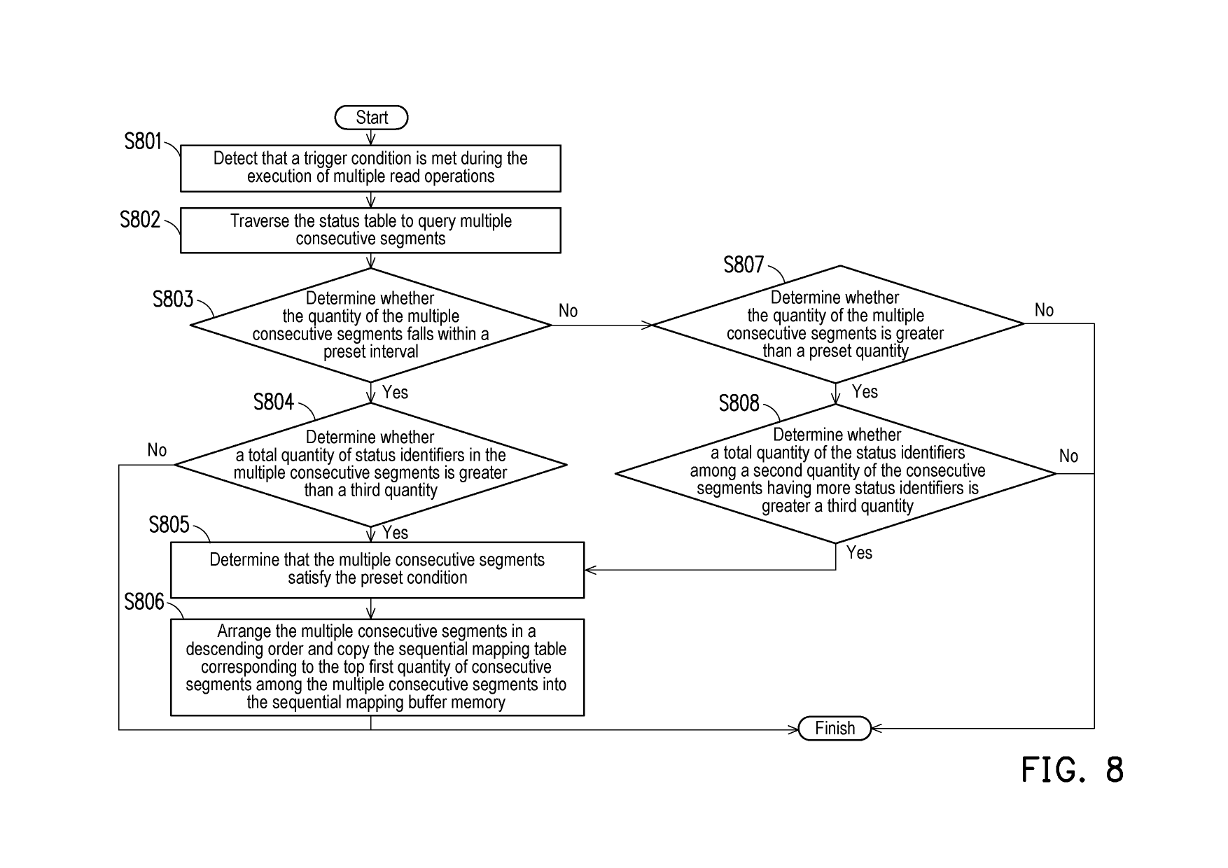

FIG. 8 illustrates a flowchart depicting a data reading control method according to an exemplary embodiment of the present disclosure.

Referring to FIG. 8, in step S801, the memory management circuit 51 detects that a trigger condition is met during the execution of multiple read operations. In an exemplary embodiment, the read operations may be, for example, consecutive read operations or random read operations. In an exemplary embodiment, the trigger condition is that the quantity of multiple read operations is greater than a preset value. In another exemplary embodiment, the trigger condition is that an amount of read data corresponding to the multiple read operations is greater than a preset amount of data. The values of the preset value and the preset amount of data may be designed according to actual requirements, and the present disclosure is not limited thereto.

In step S802, the memory management circuit 51 may traverse the status table PTE to query multiple consecutive segments. In an exemplary embodiment, the memory management circuit 51 may examine multiple status identifiers within the status table PTE to query the multiple consecutive segments. Specifically, each consecutive segment includes consecutive status identifiers, where the consecutive status identifiers are at least two adjacent status identifiers among the multiple status identifiers within the status table PTE, with the at least two adjacent status identifiers both having a first logical value (i.e., logical value 1). For instance, as illustrated in FIG. 7, the top three status identifiers within the status table PTE all have a logical value 1, therefore these three status identifiers constitute a consecutive segment.

In an exemplary embodiment, when the memory management circuit 51 queries a status identifier that is associated with a second logical value (i.e., logical value 0), the memory management circuit 51 may refrain from querying the subsequent fourth quantity (for example, 64) of status identifiers. In an exemplary embodiment, the fourth quantity is associated with logical address intervals corresponding to consecutive write operations.

Generally, the logical address intervals corresponding to the consecutive write operations are in units of 512 kB. Therefore, during the process of the memory management circuit 51 searching for consecutive segments, the search unit each time needs to be less than 512 kB (for example, 256 kB). Consequently, the fourth quantity may be defined as 256 kB (i.e., 64 status identifiers).

For example, as illustrated in FIG. 7, if the fourth status identifier in the status table PTE is the logical value 0, the memory management circuit 51 may not query the subsequent 64 status identifiers following this particular status identifier. To elaborate, the logical value 0 for the fourth status identifier indicates that there is no sequential mapping table corresponding to the logical address interval corresponding to the fourth status identifier. In other words, the logical address interval corresponding to the fourth status identifier is not mapped to a physical address interval. Consequently, the logical address intervals corresponding to the 64 status identifiers following the fourth status identifier are likely mapped to non-consecutive physical addresses. In other words, the probability of the 64 status identifiers having consecutive segments is low. Therefore, it is feasible to omit these 64 status identifiers to swiftly locate the next consecutive segment, thereby enhancing the speed at which the status table PTE is traversed.

After traversing the status table PTE, the memory management circuit 51 may subsequently determine whether the multiple consecutive segments satisfy a preset condition. For example, the memory management circuit 51 may subsequently execute step S803 and step S804 to determine whether the multiple consecutive segments satisfy the preset condition. For example, the memory management circuit 51 may proceed to execute step S803, step S807, and step S808 to determine whether the multiple consecutive segments satisfy the preset condition.

In step S803, the memory management circuit 51 may determine whether the quantity of the multiple consecutive segments falls within a preset interval. In an exemplary embodiment, the preset interval may, for example, be between four and eight. The range of the preset interval may be designed according to actual requirements, and the present disclosure does not impose any restrictions on this. If the quantity of the multiple consecutive segments falls within the preset interval, the process proceeds to step S804. Conversely, if the quantity of the multiple consecutive segments does not fall within the preset interval, the process proceeds to step S807.

In step S804, the memory management circuit 51 may determine whether a total quantity of status identifiers in the multiple consecutive segments is greater than a third quantity (for example, 128, where 128 status identifiers correspond to 512 kB).

In an exemplary embodiment, assuming the quantity of the multiple consecutive segments is eight, the memory management circuit 51 may determine whether the total quantity of status identifiers within these eight consecutive segments is greater than 128. The value of this third quantity may be designed according to actual requirements, and the present disclosure imposes no limitation on it.

If the total quantity of the status identifiers within the multiple consecutive segments is not greater than 128, then the data reading control method depicted in FIG. 8 shall be terminated. Specifically, when the total quantity of the status identifiers within the multiple consecutive segments is not greater than 128, it indicates that the status table PTE is in a highly random state, and thus the benefit of using a sequential mapping table to record the mapping relationship between the logical address interval and the physical address interval is limited. Therefore, if the total quantity of the status identifiers within the multiple consecutive segments is not greater than 128, the data reading control method depicted in FIG. 8 shall be terminated, and this status table PTE shall no longer be used.

Conversely, if the total quantity of the status identifiers within these eight consecutive segments is greater than 128, proceed to step S805.

In step S805, the memory management circuit 51 may determine that the multiple consecutive segments satisfy the preset condition.

In step S806, the memory management circuit 51 may arrange the multiple consecutive segments in a descending order and copy the sequential mapping table (also referred to as a second sequential mapping table) corresponding to the top first quantity (for example, the top four) of consecutive segments among the multiple consecutive segments into the sequential mapping buffer memory 57. In an exemplary implementation, the memory management circuit 51 may arrange the multiple consecutive segments in the descending order based on a quantity of status identifiers included therein. Subsequently, the memory management circuit 51 may copy the second sequential mapping table corresponding to the top four consecutive segments, which have the most status identifiers in the status table PTE, into the sequential mapping buffer memory 57. Accordingly, the memory management circuit 51 may construct a high-quality (for example, corresponding to multiple logical address intervals) sequential mapping table based on all the sequential mapping tables (meaning all the second sequential mapping tables) corresponding to these top four consecutive segments, thereby enhancing the performance of the memory storage device 10.

Accordingly, the memory management circuit 51 may pre-read potentially required data into the buffer memory 55 based on the information from all the sequential mapping tables corresponding to the top four consecutive segments, thereby enhancing the performance of the memory storage device 10. Furthermore, the practice of copying the top four consecutive segments into the sequential mapping buffer memory 57 may avoid the time required to load the sequential mapping table during subsequent data access operations, and may also reduce the instances of repeatedly loading different logical-to-physical mapping tables, thereby improving the data access speed of the memory storage device 10.

On the other hand, if the quantity of the multiple consecutive segments does not fall within the preset interval (i.e., four to eight), in step S807, the memory management circuit 51 may determine whether the quantity of the multiple consecutive segments is greater than a preset quantity (for example, four). The value of the preset quantity may be designed according to actual needs, and is not limited by the present disclosure. If the quantity of the multiple consecutive segments is not greater than 4, the data reading control method illustrated in FIG. 8 is terminated, and this status table PTE is no longer used. Specifically, when the quantity of the multiple consecutive segments is not greater than four, it indicates that the status table PTE is in a highly random state, thus the status table PTE will no longer be used.

On the contrary, if the quantity of the multiple consecutive segments is greater than four, proceed to step S808.

In step S808, the memory management circuit 51 may determine whether a total quantity of the status identifiers among a second quantity (for example, the top eight consecutive segments) of the consecutive segments having more status identifiers is greater a third quantity (i.e., 128). In an exemplary embodiment, assuming there are ten consecutive segments, the memory management circuit 51 may select eight consecutive segments having more status identifiers from these ten consecutive segments and determine whether a total quantity of the status identifiers among the eight consecutive segments is greater than 128. If a total quantity of nodes in these eight consecutive segments is not greater than 128, it indicates that the status table PTE is in a highly random state, thereby terminating the data reading control method of FIG. 8, and this status table PTE will no longer be used.

Conversely, if the total quantity of the status identifiers within these eight consecutive segments is greater than 128, the memory management circuit 51 may then proceed to complete step S805 and step S806. The implementation details of step S805 and step S806 have been elaborated above and will not be reiterated here.

Based on the foregoing, the memory management circuit 51 may optimize the management mechanism for the sequential mapping table based on the consecutiveness of the status table PTE, in order to construct a high-quality (for example, corresponding to multiple logical address intervals) sequential mapping table, thereby enhancing the performance of the memory storage device 10.

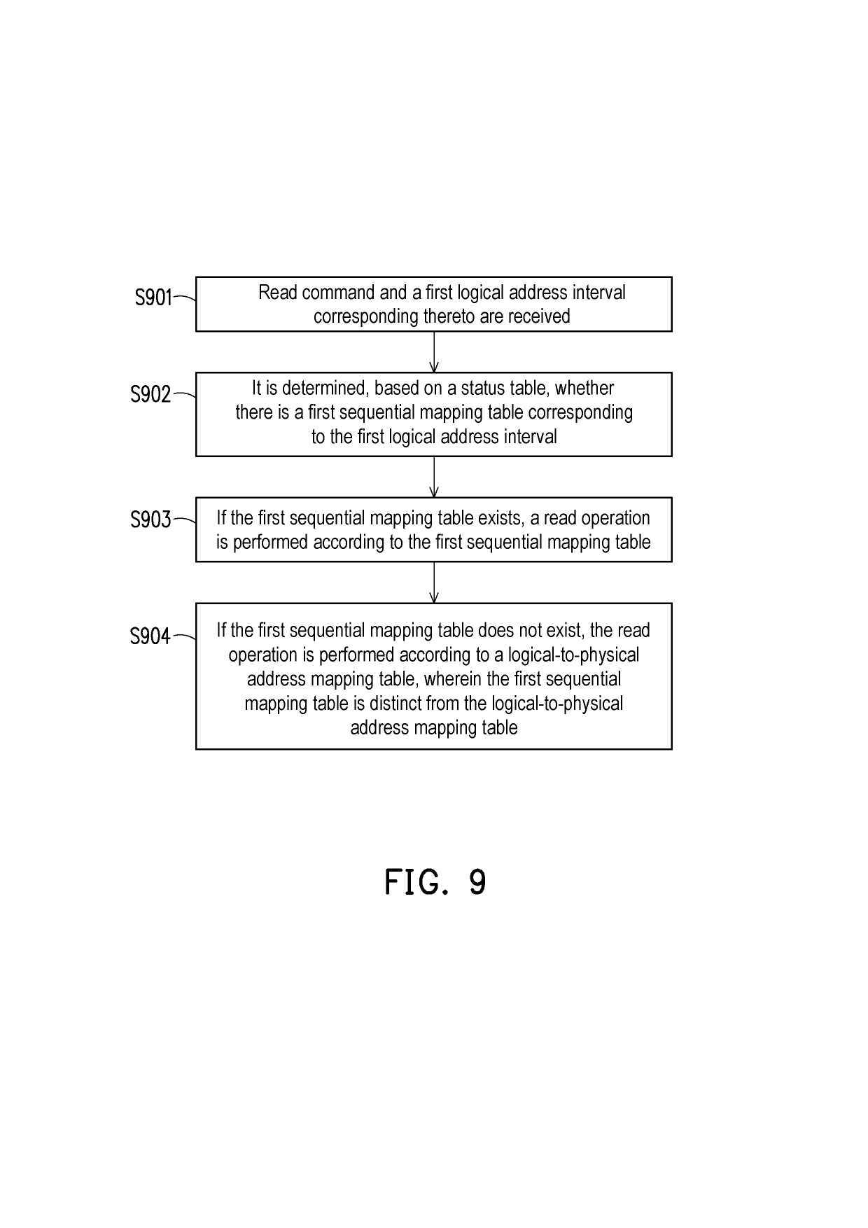

FIG. 9 illustrates a flowchart depicting a data reading control method according to an exemplary embodiment of the present disclosure. Please refer to FIG. 9. In step S901, a read command and a first logical address interval corresponding thereto are received. In step S902, it is determined, based on a status table, whether there is a first sequential mapping table corresponding to the first logical address interval. In step S903, if the first sequential mapping table exists, a read operation is performed according to the first sequential mapping table. In step S904, if the first sequential mapping table does not exist, the read operation is performed according to a logical-to-physical address mapping table, wherein the first sequential mapping table is distinct from the logical-to-physical address mapping table.

However, the steps detailed in FIG. 9 have been previously described and will not be reiterated herein. It is noteworthy that the steps outlined in FIG. 9 may be implemented as multiple code or circuits, without any limitation imposed by the present disclosure. Furthermore, the method depicted in FIG. 9 may be utilized in conjunction with the aforementioned embodiments or independently, without limitation by the present disclosure.

In conclusion, the exemplary embodiments of the present disclosure propose a data reading control method and a memory storage device that optimize the management mechanism for the sequential mapping table based on the consecutiveness of the status table. By employing the sequential mapping table to execute read operations, the execution efficiency of read operations may be accelerated, thereby enhancing the performance of the memory storage device 10.

Lastly, it should be stated that the aforementioned embodiments are provided solely for the purpose of illustrating the technical solutions of the present disclosure and should not be construed as limitations thereof. Although the present disclosure has been described in detail with reference to the aforementioned embodiments, those skilled in the art should understand that modifications can still be made to the technical solutions described in these embodiments, or that some or all of the technical features can be equivalently replaced. Such modifications or replacements do not depart from the essence of the technical solutions of the respective embodiments of the present disclosure.

What is claimed is:

1. A data reading control method for a rewritable non-volatile memory module, the data reading control method comprising:
receiving a read command and a first logical address interval corresponding thereto;
determining, according to a status table, whether a first sequential mapping table corresponding to the first logical address interval exists;
if the first sequential mapping table exists, performing a read operation based on the first sequential mapping table;
if the first sequential mapping table does not exist, performing the read operation based on a logical-to-physical address mapping table, wherein the first sequential mapping table is different from the logical-to-physical address mapping table.

2. The data reading control method according to claim 1, further comprising:
constructing the status table; and
constructing a plurality of sequential mapping tables,
wherein the status table comprises a plurality of status identifiers, and the plurality of status identifiers respectively correspond to a plurality of logical address intervals, each of the status identifiers is provided to characterize whether there is a sequential mapping table corresponding to a logical address interval corresponding to the status identifier,
the plurality of sequential mapping tables comprise the first sequential mapping table, and the plurality of logical address intervals comprise the first logical address interval.

3. The data reading control method according to claim 2, further comprising:
upon detecting that a trigger condition is met while executing a plurality of read operations, traversing the status table to query a plurality of consecutive segments;
determining whether the plurality of consecutive segments satisfy a preset condition;
if so, arranging the plurality of consecutive segments in a descending order, and copying a second sequential mapping table corresponding to a top first quantity of consecutive segments among the plurality of consecutive segments to a sequential mapping buffer memory, wherein the plurality of sequential mapping tables comprise the second sequential mapping table.

4. The data reading control method according to claim 3, wherein the step of determining whether the plurality of consecutive segments satisfy the preset condition comprises:
determining whether a quantity of the plurality of consecutive segments falls within a preset interval;
if the quantity of the plurality of consecutive segments falls within the preset interval, then determining whether a total quantity of status identifiers within the plurality of consecutive segments is greater than a third quantity;
if so, then determining that the plurality of consecutive segments satisfy the preset condition.

5. The data reading control method according to claim 4, wherein the step of determining whether the plurality of consecutive segments satisfy the preset condition further comprises:
if the quantity does not fall within the preset interval, determining whether the quantity is greater than a preset quantity;
if the quantity is greater than the preset quantity, then determining whether a total quantity of status identifiers within a second quantity of consecutive segments, having more status identifiers among the plurality of consecutive segments, is greater than the third quantity;
if so, determining that the plurality of consecutive segments satisfy the preset condition.

6. The data reading control method according to claim 3, wherein the trigger condition is that a quantity of the plurality of read operations is greater than a preset value, or an amount of read data corresponding to the plurality of read operations is greater than a preset amount of data.

7. The data reading control method according to claim 3, wherein among the plurality of status identifiers, the status identifiers that are associated with a first logical value are provided to characterize a presence of the sequential mapping table that corresponds to the logical address interval corresponding to the status identifiers,
among the plurality of status identifiers, the status identifiers that are associated with a second logical value are provided to characterize an absence of the sequential mapping table corresponding to the logical address interval corresponding to the status identifiers.

8. The data reading control method according to claim 7, wherein each of the consecutive segments comprises consecutive status identifiers, and the consecutive status identifiers are at least two adjacent status identifiers within the plurality of status identifiers, wherein the at least two adjacent status identifiers both have the first logical value.

9. The data reading control method according to claim 7, wherein the step of traversing the status table to query the plurality of consecutive segments comprises:
if the status identifier associated with the second logical value is queried, a subsequent fourth quantity of status identifiers are not queried, wherein the fourth quantity is associated with logical address intervals corresponding to consecutive write operations.

10. The data reading control method according to claim 3, wherein the step of arranging the plurality of consecutive segments in the descending order comprises:
arranging the plurality of consecutive segments in the descending order based on a quantity of status identifiers comprised therein.

11. A memory storage device, comprising:
a connection interface unit, configured to couple to a host system;
a rewritable non-volatile memory module; and
a memory control circuit unit, coupled to the connection interface unit and the rewritable non-volatile memory module, and comprising a sequential mapping buffer memory,
wherein the memory control circuit unit is configured to:
receive a read command and a first logical address interval corresponding thereto;
determine, based on a status table, whether a first sequential mapping table corresponding to the first logical address interval exists;
if the first sequential mapping table exists, perform a read operation according to the first sequential mapping table;
if the first sequential mapping table does not exist, perform the read operation based on a logical-to-physical address mapping table, wherein the first sequential mapping table is different from the logical-to-physical address mapping table.

12. The memory storage device according to claim 11, wherein the memory control circuit unit is further configured to:
construct the status table; and
construct a plurality of sequential mapping tables,
wherein the status table comprises a plurality of status identifiers, the plurality of status identifiers respectively correspond to a plurality of logical address intervals, each of the status identifiers is provided to characterize whether there is a sequential mapping table corresponding to a logical address interval corresponding to the status identifier,
the plurality of sequential mapping tables comprise the first sequential mapping table, and the plurality of logical address intervals comprise the first logical address interval.

13. The memory storage device according to claim 12, wherein the memory control circuit unit is further configured to:
upon detecting that a trigger condition is met while executing a plurality of read operations, traverse the status table to query a plurality of consecutive segments;
determine whether the plurality of consecutive segments satisfy a preset condition;
if so, arrange the plurality of consecutive segments in a descending order, and copy a second sequential mapping table corresponding to a top first quantity of consecutive segments among the plurality of consecutive segments to a sequential mapping buffer memory, wherein the plurality of sequential mapping tables comprise the second sequential mapping table.

14. The memory storage device according to claim 13, wherein the memory control circuit unit is further configured to:
determine whether a quantity of the plurality of consecutive segments falls within a preset interval;
if the quantity of the plurality of consecutive segments falls within the preset interval, then determine whether a total quantity of status identifiers within the plurality of consecutive segments is greater than a third quantity;
if so, then determine that the plurality of consecutive segments satisfy the preset condition.

15. The memory storage device according to claim 14, wherein the memory control circuit unit is further configured to:
if the quantity does not fall within the preset interval, determine whether the quantity is greater than a preset quantity;
if the quantity is greater than the preset quantity, then determine whether a total quantity of status identifiers within a second quantity of consecutive segments, having more status identifiers among the plurality of consecutive segments, is greater than the third quantity;
if so, determine that the plurality of consecutive segments satisfy the preset condition.

16. The memory storage device according to claim 13, wherein the trigger condition is that a quantity of the plurality of read operations is greater than a preset value, or an amount of read data corresponding to the plurality of read operations is greater than a preset amount of data.

17. The memory storage device according to claim 13, wherein among the plurality of status identifiers, the status identifiers that are associated with a first logical value are provided to characterize a presence of the sequential mapping table that corresponds to the logical address interval corresponding to the status identifiers,
among the plurality of status identifiers, the status identifiers that are associated with a second logical value are provided to characterize an absence of the sequential mapping table corresponding to the logical address interval corresponding to the status identifiers.

18. The memory storage device according to claim 17, wherein each of the consecutive segments comprises consecutive status identifiers, and the consecutive status identifiers are at least two adjacent status identifiers within the plurality of status identifiers, wherein the at least two adjacent status identifiers both have the first logical value.

19. The memory storage device according to claim 17, wherein the memory control circuit unit is further configured to:
if the status identifier associated with the second logical value is queried, not to query a subsequent fourth quantity of status identifiers, wherein the fourth quantity is associated with logical address intervals corresponding to consecutive write operations.

20. The memory storage device according to claim 13, wherein the memory control circuit unit is further configured to:
arrange the plurality of consecutive segments in the descending order based on a quantity of status identifiers comprised therein.
